(19) United States
(12) Patent Application Publication
(10) Pub. No.: US 2016/0178882 A1
(43) Pub. Date: Jun. 23, 2016

(54) CONTROL SYSTEM FOR A MICROSCOPE AND METHOD FOR CONTROLLING A MICROSCOPE

(71) Applicant: Carl Zeiss Microscopy GmbH, Jena (DE)

(72) Inventors: Christof KRUG, Munich (DE); Friedrich Wilhelm VIERECK, Munich (DE); Roger LANDOLT, Munich (DE); Martin KUTTGE, Munich (DE); Wolfgang BAYERLEIN, Zolling (DE)

(21) Appl. No.: 14/970,389

(22) Filed: Dec. 15, 2015

(30) Foreign Application Priority Data
Dec. 17, 2014 (DE) 102014118891.8

(51) Int. Cl. G02B 21/36; H04N 5/232

(52) U.S. Cl. CPC G02B 21/365; H04N 5/23222

(57) ABSTRACT

A control system for a microscope having a sample stage for carrying an object, an imaging lens system for imaging the object and a digital capture unit for capturing the imaged object. The system provides a first operating mode wherein a user with first user rights can compile and define a work sequence for capturing the object and for evaluating the captures. The system or a first user can predefine which changes in the sequence and/or parameters influencing the sequence are possible, but a user with second user rights cannot. The system also provides a second operating mode in which a user with the second user rights can select and perform the defined work sequence. The control system enables the user with the second user rights to make changes in the sequence and/or of the parameters influencing the selected work sequence only within the predefined framework while blocking other changes.

### PRIORITY CLAIM

The present application claims priority to German Patent Application No. 102014118891.8, filed on Dec. 17, 2014, which said application is incorporated by reference in its entirety herein.

### FIELD OF THE INVENTION

The present invention relates to a control system for a microscope and a method for controlling a microscope.

### BACKGROUND OF THE INVENTION

The ongoing improvement of microscopes means that they are, depending on the chosen design, very complex measuring devices which offer a multiplicity of possibilities for capturing, measuring and evaluating. Therefore, users who are to carry out relatively simple capture, measurement and evaluation tasks can be overwhelmed by the possibilities provided and thus by the complexity of the microscope, with the result that a capture, measurement and evaluation task that is unproblematic to carry out with the microscope cannot be implemented by the user. Furthermore, a complex capture, measurement and evaluation task can be available and while lacking simple operability.

### SUMMARY OF THE INVENTION

An object of the invention is therefore to provide a control system for a microscope which makes possible simple operability even in the case of very complex microscopes. Furthermore, a corresponding method for controlling a microscope is to be provided.

The object is achieved by a control system for a microscope which has a sample stage for carrying an object, an imaging lens system for imaging the object carried by the sample stage and a digital capture unit for capturing the imaged object, in that the control system is designed such that it provides a first operating mode in which a user with first user rights can compile and define at least one work sequence for capturing the object and for evaluating the captures in such a way that it is predefined which changes in the work sequence and/or the parameters influencing the work sequence are possible, but a user with second user rights cannot. The microscope provides a second operating mode in which a user with the second user rights can select and perform one of the defined work sequences, wherein the control system enables the user with the second user rights, when performing the selected work sequence, to make changes in the selected work sequence and/or the parameters influencing the selected work sequence only within the predefined framework, and blocks other changes.

By means of the two operating modes of the control system, an experienced user who has first user rights can configure and thus predefine the work sequence for a less experienced user who has second user rights and only permit changes or variations in the scope which are absolutely necessary for a capture, measurement and evaluation task which is to be performed. It is thus advantageously achieved that the user with the second user rights is provided with a microscope which is simpler for him to operate and thus he can easily perform the capture, measurement and evaluation task. It is also possible to design even a complex capture, measurement and evaluation task to be simple to operate by means of a defined work sequence.

With the control system according to the invention, a configurable sequence control can be realized.

The control system according to the invention can be designed such that, in the first operating mode, an individually configurable user interface can be compiled and defined for each defined work sequence. In particular, a user-friendly user interface (e.g., a user-friendly layout) can be defined. The user interface can preferably be compiled and defined simultaneously with the compilation and definition of the respective work sequence.

The control system according to the invention can be designed such that, in the first operating mode, it provides several basic segments (which can also be called tools), from which the work sequence can be compiled. These can be basic segments of a piece of microscope software.

By a basic segment is meant one or more step(s) which are necessary for compiling a work sequence. This can, in particular, be one or more step(s) for controlling the microscope (e.g., setting magnification, focus position, illumination, position of the sample stage, etc.), for capturing the image, for processing the captured image, for evaluating the processed image and/or for generating an output document (which contains, e.g., images, tables, diagrams, reports, forms, etc.).

Furthermore, the control system can be designed such that, in the first operating mode, it provides at least two groups each with several basic segments and ensures that at least one basic segment from each of the groups is contained in the defined work sequence. It can thereby be achieved that a performable work sequence is easily defined.

The groups can include a capture group, which relates to the image capture, a data processing group, which relates to the processing of the captured images, an evaluation group, which relates to the evaluation of the processed images or other supplied images, a report group, which relates to the generation of a corresponding output document, and/or a general group, the basic segments of which can be provided at various points in the work sequence.

Furthermore, the control system can be designed such that, in the first operating mode, it ensures that mutually dependent basic segments can only be selected together for the work sequence to be defined. This also makes the compiling of a work sequence easier.

In addition, the control system can be designed such that a user with the first user rights can predefine in the first operating mode standard values for the parameters influencing the work sequence.

By the parameters influencing the work sequence is meant here in particular that different values of such parameters lead to different results. These can, e.g., be parameters in the imaging of the object, parameters in the capturing of the object, parameters in the processing of the captured captures and parameters in the evaluation of the captures.

In addition, the control system according to the invention can be designed such that a user with the first user rights can define, in the first operating mode, whether, and if so, within what framework, a parameter can be changed by the user with the second user rights while performing the defined work sequence. Thus, for example, a lower limit value and/or an upper limit value can be defined for a parameter.

The control system according to the invention can be designed such that a user with first user rights can define in the first operating mode whether a parameter influencing the work sequence is displayed or not displayed (e.g., via an output unit, such as, for example, a screen) in the second operating mode when the defined work sequence is being performed. It is thereby possible to design the user interface in the second operating mode to be clearer. In particular, it is possible for parameters which are not required or parameters which cannot be changed not to be displayed, with the result that the user with the second user rights does not have to grapple with these parameters.

The control system according to the invention can be designed such that, in the second operating mode, a user with third user rights can freely set a work sequence and/or such that the user with third user rights can operate the microscope without limitations. A user with third user rights is preferably such a user who is experienced in the operation of the microscope and can thus use, if possible, all of the properties of the microscope.

The control system is preferably designed as hardware and software.

In addition, there is provided a microscope system with a microscope that has a sample stage for carrying the object, an imaging lens system for imaging the object carried by the sample stage and one or more digital capture units (e.g., a digital camera or a capturing sensor for generating a digital image) for capturing the imaged object, and with a control system according to the invention (including further developments thereof).

The object is achieved in addition by a method for controlling a microscope which has a sample stage for carrying an object, an imaging lens system for imaging the object carried by the sample stage and a digital capture unit for capturing the imaged object, in which in a first step a user with first user rights can compile and define at least one work sequence for capturing the object and for evaluating the capture in such a way that it is predefined which changes in the work sequence and/or of the parameters influencing the work sequence are possible but a user with second user rights cannot, and in a second step a user with the second user rights can select and perform one of the defined work sequences, wherein the user with the second user rights, when performing the selected work sequence, is enabled to make changes in the selected work sequence and/or of the parameters influencing the selected work sequence only within the predefined framework and other changes are blocked.

It is understood that the features mentioned above and those yet to be explained in the following are applicable not only in the stated combinations, but also in other combinations or singly, without departing from the scope of the present invention.

### BRIEF DESCRIPTION OF THE DRAWINGS

The invention is explained by way of example in yet more detail in the following with reference to the attached drawings, which also disclose features essential to the invention. There are shown in:

FIG. 1 a schematic view of a control unit 1 according to an embodiment as well as a microscope 2 controlled by means of the control unit;

FIG. 2 a schematic flow diagram of the method according to an embodiment for controlling a microscope;

FIG. 3 a schematic representation to explain the compilation of a work sequence in the first operating mode of the control unit;

FIG. 4 a representation to explain the settable parameters of the tool A2, and

FIG. 5 three different defined work sequences Z1, Z2 and Z3.

### DETAILED DESCRIPTION

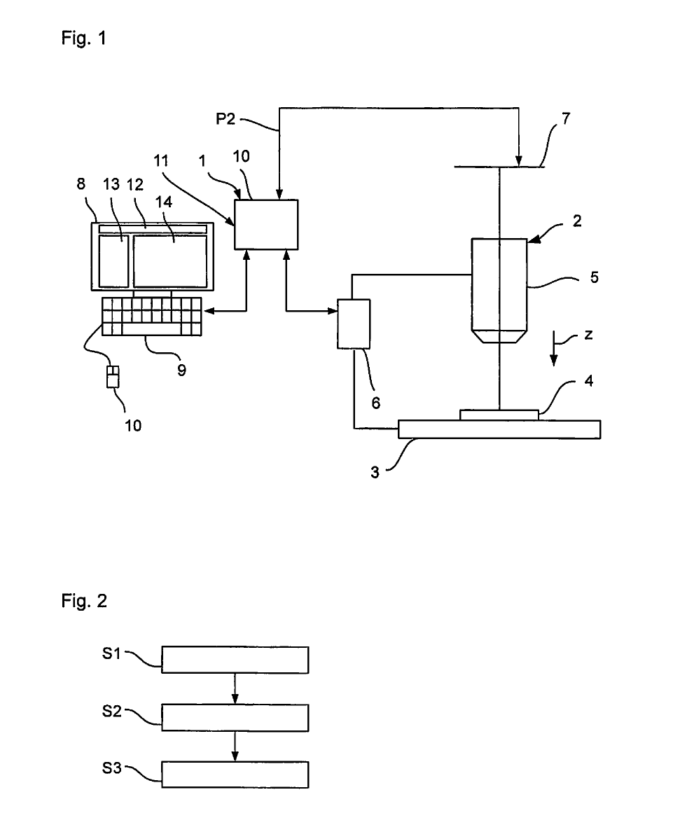

In the embodiment shown in FIG. 1, a control system 1 according to the invention (or control equipment 1 according to the invention) is shown together with a microscope 2 to be controlled.

The microscope 2 comprises a sample stage 3, which carries a sample 4, an imaging lens system 5, a movement unit 6 as well as a digital capture unit 7. By means of the imaging lens system 5, during the operation of the microscope 2, a magnified image (e.g., of part) of the sample 4 is generated, which image is captured by means of the digital capture unit 7. The digital capture unit 7 can have a sensor (e.g., CCD sensor or CMOS sensor) in order to be able to capture a digital image. The movement unit 6 is designed such that it can alter the distance along a z direction between the imaging lens system 5 and the sample stage 3, and consequently the sample 4 and/or the position of the sample stage 3 relative to the position of the imaging lens system 5 in a plane perpendicular to the z direction. By altering the distance in the z direction, different focal positions or imaging positions can be set. A change of position in the plane perpendicular to the z direction can serve to approach a particular lateral position of the sample 4.

The microscope 2 can, under the control of the control system 1, run through a predetermined work sequence, which comprises, e.g., an automatic capture of images of the sample 4, a processing of the captured images, an analysis of the captured images and the generation of a report. The possibilities for defining such a work sequence are described in detail in the following.

The control system 1 can have an output unit 8, such as, e.g., a screen 8, as well as an input unit 9, 10, e.g., a keyboard 9 and/or a computer mouse 10. Of course, it is also possible for the output unit 8 to be designed in addition or alternatively as an input unit. For example, the screen 8 can be touch-sensitive.

The control system 1 is designed in such a way that it can carry out the steps described in the following in connection with FIGS. 2 to 5. One property of the control system 1 is that different setting possibilities are provided depending on the user rights assigned to the respective user. Thus, a user with first user rights can define a work sequence for capturing the object and evaluating the captures. The user with the first user rights can predefine which changes in the defined work sequence and/or which changes of the parameters which influence the defined work sequence are possible. A user with second user rights can then select and perform the defined work sequence. A user with second user rights cannot, however, define a new work sequence. Thus, a user with second user rights can only change a defined work sequence to the extent that this was predefined during the definition by the user with first user rights.

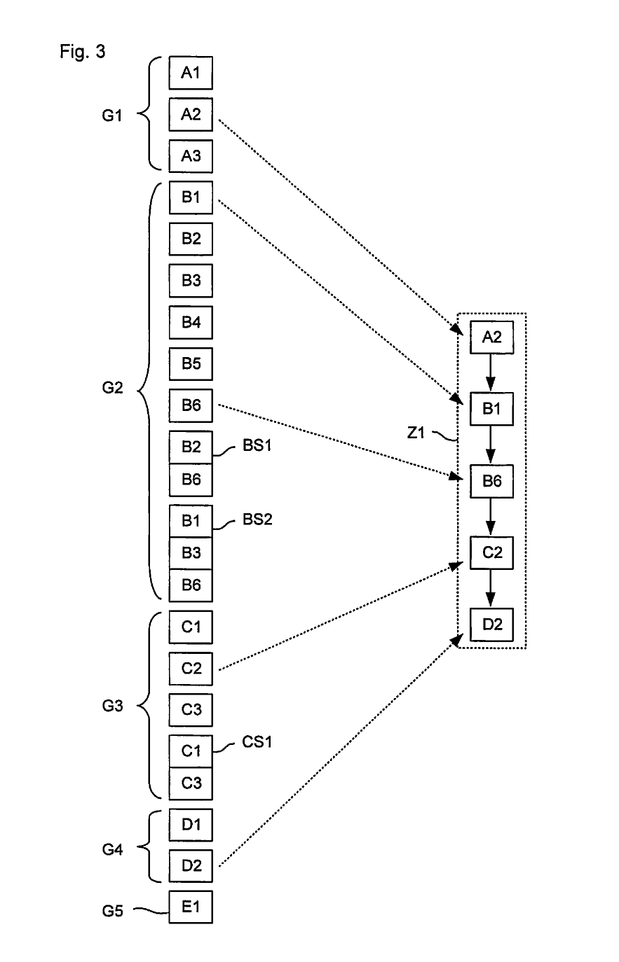

In a first step S1 (FIG. 2), the control system 1 provides a first input interface via which the user with first user rights can define the desired work sequence. The provision of the first input interface can also be called the first operating mode of the control system 1. In the first operating mode, e.g., a first graphical user interface, can be displayed on the screen 8. The first graphical user interface can, e.g., have a first area 12 for a menu bar, a second area 13 and a third area 14, as is shown schematically in FIG. 1. In the first operating mode, different basic segments, from which the desired work sequence can be formed, are provided, for example, (and, e.g., shown in the second area 13 or at any other point of the screen 8). The basic segments, which can also be called tools, are each labeled in FIG. 3 with the letters A, B, C, D or E and an added digit in order to be able to distinguish them.

It is assumed that the tools A1, A2 and A3 represent different possibilities for image capture. The tool A1 represents an individual image capture, the tool A2 represents the capture of a z stack (i.e., the capture of several images with different focal positions) and the tool A3 represents the capturing of laterally offset individual captures in order to generate an image therefrom. The tools A1-A3 thus relate to image capture or more generally data collection and can therefore be understood as elements of a capture group G1.

The tool B1 represents a first noise filter, the tool B2 represents a second noise filter, the tool B3 represents a color filter, the tool B4 represents the identification of the capture with the best focusing, the tool B5 represents the generation of a three-dimensional image and the tool B6 represents the generation of an image with increased depth of field. Thus, the tools B1-B6 can be assigned to a data processing group G2.

In the embodiment described here, the data processing group G2 comprises not only the tools B1-B6, but also two so-called toolkits which are already a combination of basic segments. The toolkit BS1 comprises the tools B2 and B6 and the toolkit BS2 comprises the tools B1, B3 and B6.

The tool C1 represents the automatic identification of a linewidth of the capture supplied to the tool, the tool C2 represents the automatic identification of the number of particles in the capture supplied to the tool and the tool C3 represents the locating of a predefined pattern in the supplied capture. The tools C1-C3 are contained in an analysis group G3, which contains in addition the toolkit CS 1, which is a combination of the tools C1 and C3.

The tool D1 represents the generation of a first report and the tool D2 represents the generation of a second report. These reports can be generated, for example, as Microsoft® WORD documents or as Adobe® PDF documents and can contain images, tables, diagrams, forms etc. The tools D1 and D2 are constituents of a so-called report group G4.

The tool E1 is, e.g., a zoom tool and is a constituent of a so-called global group G5.

These tools and toolkits are provided to the user with the first user rights in the first operating mode (simultaneously and sequentially in time, e.g., group by group), with the result that the user with the first user rights can compile the first work sequence Z1 represented schematically in FIG. 3. In the embodiment described here, there is the constraint that at least one tool or one toolkit must be selected from each of the groups G1, G2, G3 and G4 in order to compile a work sequence.

In the case of each tool, settable parameters can be available, the values of which the user with first user rights can predefine. Furthermore, the user with the first user rights can set whether or not these parameters can be changed by the user with second user rights when the work sequence is being performed. It is also possible for the user with first user rights to be able to set whether the parameters are even visible. By visible is meant here in particular that the parameters are displayed on the screen 8 (e.g., in the second or third area 13, 14). If the parameter is set as not visible, it is not displayed.

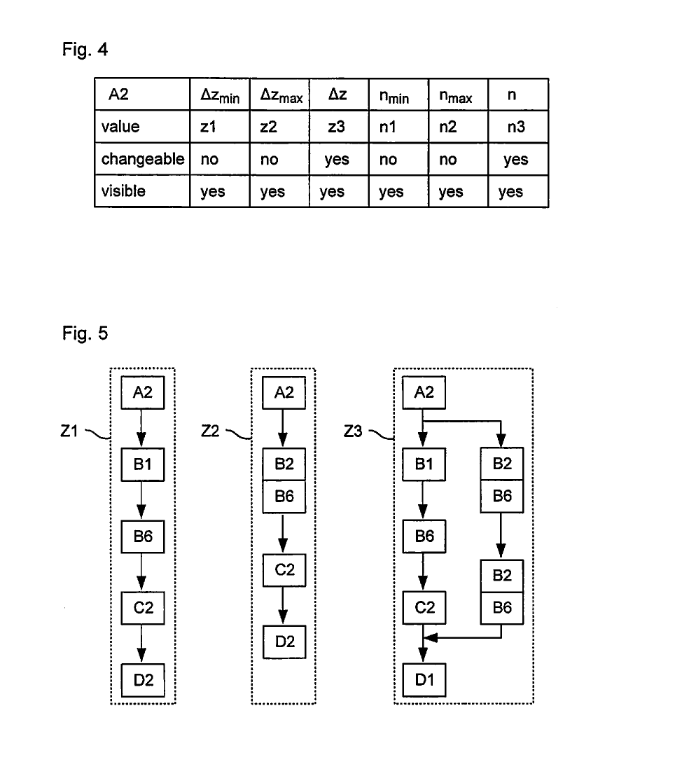

The setting of parameter 4 for the tool A2 is represented schematically in FIG. 4. For the tool A2, the minimum distance Δzₘᵢₙ of the first and last focal position of the z stack to be captured, the maximum distance Δzₘₐₓ of the first and last focal position of the z stack to be captured as well as the distance Δz of the first and last focal position of the z stack to be captured can be set. Furthermore, the minimum number nₘᵢₙ of the z steps to be carried out, and therefore of the captures to be carried out, the maximum number nₘₐₓ of the z steps to be carried out as well as the number n of the z steps to be carried out of the z stack to be captured can be set.

As is shown in the table in FIG. 4, values (z1, z2, z3, n1, n2, n3) are predefined for all of these parameters. It is further predefined that only the parameter Δz and the parameter n can be changed by a user with second user rights. The other parameters cannot be changed by the user with second user rights. All of the parameters are visible and are therefore displayed (e.g., in the second area 13) to the user while performing the work sequence Z1. It is also possible not to display parameters the values of which for example are set to be unchangeable to the user with second user rights while the first work sequence Z1 is being carried out in order thus, for example, to simplify operation.

The control system 1 can in particular be designed such that, in the first operating mode, it is not possible to compile tools which would lead to a work sequence which cannot be performed. This can be achieved, e.g., in that when the work sequence is compiled, after the selection of a first tool, only those tools which lead to a performable work sequence can be selected. In particular, e.g., in the case of the tools of the data processing group G2 and of the analysis group G3, it can be defined which tool of the capture group G1 is obligatory. It is therefore possible, after the selection of a tool A1, A2 or A3 from the capture group G1, to determine explicitly which tools from the data processing group G2 and from the analysis group G3 lead to a performable work sequence. Only these tools of the groups G2 and G3 can then be selected. Other dependencies on tools of different groups or of the same groups can also be stored for the respective tool, with the result that the compiled work sequences can be performed.

The tool E1 of the global group is a tool which can be provided at any point of the work sequence but which does not have to be provided.

The number of tools per group G1-G5, as they are represented in FIG. 3, is to be understood as being only by way of example. Of course, each of the groups G1-G5 shown can contain more or fewer tools and/or toolkits. The number of groups G1-G5 is also to be understood as being only by way of example. The number of groups can be larger or smaller. Groups can also be designed for different tasks for the work sequence to be defined.

In this way, a user with first user rights can define the work sequences Z1, Z2 and Z3 represented schematically in FIG. 5, from which a user with second user rights can select (step S2 in FIG. 2) and then perform (step S3 in FIG. 2) a work sequence Z1, Z2 or Z3. For this, the control system provides a second input interface via which this selection and then performance of the selected work sequence is made possible. The provision of the second input interface can also be called the second operating mode of the control system 1. In the second operating mode, e.g., a second graphical user interface can be displayed on the screen 8. The selectable work sequences Z1, Z2 and Z3 (which can also be called work sequence templates) can thus be displayed and selected on the screen 8. After selection, the selected work sequence can be displayed, e.g., in the second area 13. In the third area 14, the obtained data (e.g., images, diagrams, etc.) can be displayed after the step respectively carried out in the work sequence.

In the second operating mode, the control system 1 ensures in particular that, when performing the selected work sequence Z1, Z2 or Z3, the user with second user rights can make changes in the work sequence and/or of the parameters influencing the work sequence only within the framework as permitted by the user with first user rights during the compiling of the corresponding work sequence Z1, Z2, Z3. Other changes are blocked by the control system 1, with the result that it is ensured that the user with second user rights can perform the selected work sequence Z1, Z2, Z3 only within the predetermined framework.

It is thus achieved that even a very complex microscope 2 which is difficult to operate can be set for predetermined work sequences such that even users with little experience can achieve the desired results.

When the control system 1 according to the invention provides the first input interface, it is thus in the first operating mode. When the second input interface is provided, the control system 1 is in the second operating mode. Thus, it can also be said that the control system 1 according to the invention provides at least two different operating modes, wherein, in the first operating mode, a user with first user rights can define a work sequence and predefine which changes in the work sequence and/or of the parameters influencing the work sequence are possible. A user with second user rights cannot access the first operating mode and thus cannot predefine a work sequence.

In the second operating mode, a user with second user rights can select and perform one of the defined work sequences.

Of course, the control system 1 can have more than two different operating modes. Thus, a third operating mode can be available in which a user with third user rights can define a work sequence for himself. The user with third user rights is thus not limited to predefined work sequences. He can, however, use them to compile his own work sequences. However, he cannot generate these compiled work sequences as predefined work sequences for users with second user rights.

The control system 1 can, in particular, guarantee the differentiation of the users in that each user must register with the control system 1 or with a corresponding program or application of the control system 1, wherein for each user who can register, it is stored which user rights he has. Other types of authorization and identification of the corresponding users are also possible. For example, access cards (chip cards, magnetic cards, etc.) can be issued with which the corresponding user permission is linked. These access cards are evaluated by the control system 1 and then the correspondingly stored user rights are assigned to the user.

Together with the microscope 2, the control system 1 forms a microscope system 11 according to the invention.

The microscope 2 can be a reflected light microscope, a transmitted light microscope, a fluorescence microscope, a darkfield microscope, a laser scanning microscope, an electron microscope, an X-ray microscope, any combination of the named microscopes or another microscope.

What is claimed is:

1. A control system for a microscope which has a sample stage for carrying an object, an imaging lens system for imaging the object carried by the sample stage and a digital capture unit for capturing the imaged object, wherein the control system is designed such that it
provides a first operating mode in which a user with first user rights can compile and define at least one work sequence for capturing the object and for evaluating the captures in such a way that it is predefined which changes in the work sequence and/or of parameters influencing the work sequence are possible, but a user with second user rights cannot, and
provides a second operating mode in which a user with the second user rights can select and perform one of the defined work sequences, and
wherein the control system enables the user with the second user rights, when performing the selected work sequence, to make changes in the selected work sequence and/or of the parameters influencing the selected work sequence only within the predefined framework, and blocks other changes.

2. The control system according to claim 1 which is designed such that, in the first operating mode, an individually configurable user interface can be compiled and defined for each defined work sequence.

3. The control system according to claim 1 which is designed such that, in the first operating mode, the control system provides several basic segments from which the work sequence can be defined.

4. The control system according to claim 1 which is designed such that, in the first operating mode, the control system provides at least two groups each with several basic segments and ensures that at least one basic segment from each of the groups is contained in the defined work sequence.

5. The control system according to claim 3 which is designed such that, in the first operating mode, the control system ensures that mutually dependent basic segments can only be selected together for the work sequence to be defined.

6. The control system according to claim 4 which is designed such that, in the first operating mode, the control system ensures that mutually dependent basic segments can only be selected together for the work sequence to be defined.

7. The control system according to claim 1 which is designed such that a user with the first user rights can define, in the first operating mode, whether, and if so, within what framework, a parameter can be changed by the user with the second user rights while performing the defined work sequence.

8. The control system according to claim 1 which is designed such that a user with first user rights can define in the first operating mode whether a parameter influencing the work sequence is displayed or not displayed in the second operating mode when the defined work sequence is being performed.

9. The control system according to claim 1 which is designed such that, in the second operating mode, a user with third user rights can freely set a work sequence.

10. A microscope system with a microscope which has a sample stage for carrying an object, an imaging lens system for imaging the object carried by the sample stage and a digital capture unit for capturing the imaged object, and with a control system according to claim 1.

11. A method for controlling a microscope which has a sample stage for carrying an object, an imaging lens system for imaging the object carried by the sample stage and a digital capture unit for capturing the imaged object, comprising:
a first step in which a user with first user rights can define at least one work sequence for capturing the object and for evaluating the capture in such a way that it is predefined which changes in the work sequence and/or of the parameters influencing the work sequence are possible but a user with second user rights cannot, and
a second step in which a user with the second user rights can select and perform one of the defined work sequences,
wherein the user with the second user rights, when performing the selected work sequence, is enabled to make changes in the selected work sequence and/or of the parameters influencing the selected work sequence only within the predefined framework, and other changes are blocked.
